(19) United States
(12) Patent Application Publication
(10) Pub. No.: US 2022/0057692 A1
(43) Pub. Date: Feb. 24, 2022

(54) BLADE OPEN-CLOSE DEVICE AND ELECTRONIC DEVICE

(71) Applicant: Nidec Copal Corporation, Tokyo (JP)

(72) Inventors: Ryosuke USHIO, Tokyo (JP); Kenzo IMAI, Tokyo (JP); Koji SAWANOBORI, Tokyo (JP); Nobuaki WATANABE, Tokyo (JP)

(21) Appl. No.: 17/402,615

(22) Filed: Aug. 16, 2021

(30) Foreign Application Priority Data
Aug. 21, 2020 (JP) 2020-140318

(51) Int. Cl. G03B 11/04; G06F 1/16

(52) U.S. Cl. CPC G03B 11/043; G06F 1/1686

(57) ABSTRACT

A blade open-close device mountable on a module board including a lens unit includes a base including peripheral walls adjacent to the lens unit, a cover plate covering at least part of the base, and a blade movable in a blade chamber between the cover plate and a surface of the peripheral walls. A partition and the cover plate each have an opening aligned with an optical axis of the lens unit. The blade open-close device includes an actuator that moves the blade between a closing position to cover the openings and an opening position to uncover the openings. A distance from the surface of the peripheral walls to a surface of the cover plate opposite to the base along the optical axis is one fifth or less of a total of a thickness of the module board and a height of the lens unit measured along the optical axis.

### RELATED APPLICATIONS

The present application claims priority to Japanese Application Number 2020-140318, filed Aug. 21, 2020, the disclosure of which is hereby incorporated by reference herein in its entirety.

### BACKGROUND

### Technical Field

The present invention relates to a blade open-close device and an electronic device, and particularly, to a blade open-close device for covering and uncovering an opening with a blade.

### Description of the Background

Recent electronic devices, such as smartphones, smart speakers, and drones, incorporate a camera. Such a camera typically has a lens aperture constantly uncovered, or being constantly ready for image capturing. In this state, the camera may be operated by a malicious third party, possibly capturing images or videos unintended by the user. Such images or videos can be used for crime.

In particular, an electronic device incorporating a camera is now often connected to a network such as the Internet. The connected electronic device may be operated remotely by a malicious program without being noticed by the user. When the electronic device is operated remotely, image capturing may be performed without being noticed by the user, possibly allowing the camera to capture images or videos for transmission to external devices. For privacy protection of the user, structures are awaited for preventing image capturing with a camera as unintended by the user.

Such structures for preventing image capturing with a camera may include a known camera shutter that opens and closes a blade between a lens and a subject (refer to, for example, Patent Literature 1). However, the camera shutter may not fit in an electronic device that is smaller and has a limited space for a camera module. In particular, recent electronic devices tend to incorporate a camera module to be smaller in the optical axis direction of a lens, or in other words, to be thinner.

### CITATION LIST

### Patent Literature

Patent Literature 1: Japanese Unexamined Patent Application Publication No. 2009-288327

### BRIEF SUMMARY

In response to the above issue, one or more aspects of the present invention are directed to a thin blade open-close device incorporated in a limited space and an electronic device including the blade open-close device.

A thin blade open-close device according to a first aspect of the present invention can be incorporated in a limited space. The blade open-close device is mountable on a module board including a lens unit. The blade open-close device includes a base located on the module board and including walls adjacent to the lens unit and a cover plate covering at least part of the base. The cover plate has an opening aligned with an optical axis of the lens unit. The blade open-close device includes a blade movable in a direction perpendicular to the optical axis in a blade chamber defined between the cover plate and an upper surface of the walls of the base and an actuator that moves the blade between a closing position to cover the opening and an opening position to uncover the opening. A distance from the upper surface of the walls of the base to a surface of the cover plate opposite to the base along the optical axis is one fifth or less of a total of a thickness of the module board and a height of the lens unit measured along the optical axis.

An electronic device according to a second aspect of the present invention includes a module board, a lens unit mounted on the module board, and the blade open-close device described above.

### BRIEF DESCRIPTION OF DRAWINGS

FIG. 1 is a perspective view of a blade open-close device according to one embodiment of the present invention, together with a module board and a lens unit.

FIG. 2 is an exploded perspective view of the blade open-close device in FIG. 1.

FIG. 3 is a schematic longitudinal cross-sectional view of the blade open-close device in FIG. 1.

FIG. 4A is a schematic plan view of an actuator shown in FIG. 2, showing its example operation.

FIG. 4B is a schematic plan view of the actuator shown in FIG. 2, showing its example operation.

FIG. 5A is a schematic plan view of a blade at a position moved by the actuator shown in FIG. 4A.

FIG. 5B is a schematic plan view of the blade at a position moved by the actuator shown in FIG. 4B.

FIG. 6 is a partial cross-sectional view of the blade open-close device in FIG. 3.

FIG. 7 is a schematic diagram of a laptop personal computer as an electronic device according to one embodiment of the present invention.

### DETAILED DESCRIPTION

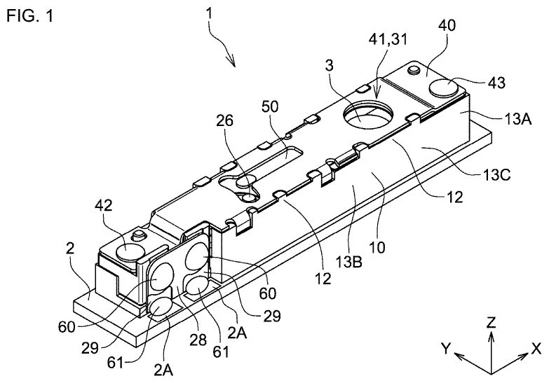

A blade open-close device according to one or more embodiments of the present invention will now be described in detail with reference to FIGS. 1 to 7. In FIGS. 1 to 7, the same or corresponding components are given the same reference numerals, and will not be described repeatedly. In FIGS. 1 to 7, the scale and dimensions of each component may be exaggerated, or one or more components may not be shown. Unless otherwise specified, the terms such as first and second will be used simply to distinguish the components and will not represent a specific order or sequence.

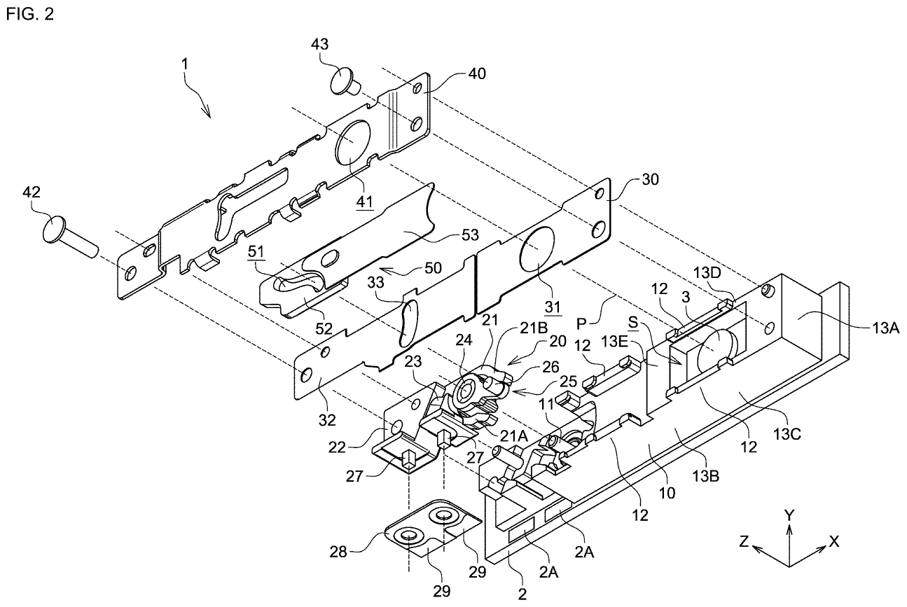

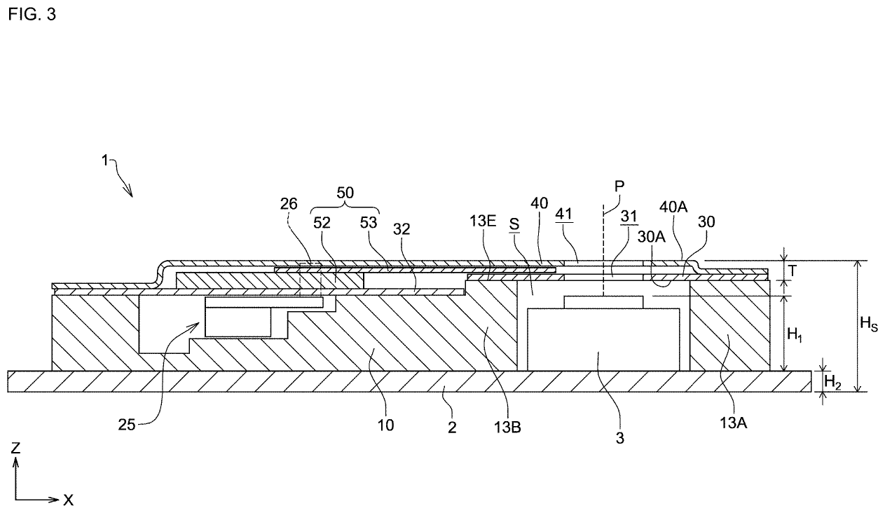

FIG. 1 is a perspective view of a blade open-close device 1 according to one embodiment of the present invention. FIG. 2 is an exploded perspective view of the device, and FIG. 3 is a schematic longitudinal cross-sectional view of the device. As shown in FIGS. 1 and 2, the blade open-close device 1 according to the present embodiment is mounted on, for example, a camera module incorporated in an electronic device, and more specifically, on a module board 2 on which a lens unit 3 is mounted. For ease of understanding, in FIG. 3, some parts are shown simply or not shown, and the dimensions of other parts are exaggerated. For ease of explanation in the present embodiment, up or upward refers to the positive Z-direction in FIG. 1, and down or downward refers to the negative Z-direction.

As shown in FIGS. 1 to 3, the blade open-close device 1 includes a base 10 attached to the module board 2, an actuator 20 located on the base 10, a partition 30 located opposite to the module board 2 from the base 10, a cover plate 40 covering an upper portion of the base 10, a blade 50 located between the cover plate 40 and the partition 30, and a partition 32 located between the actuator 20 and the blade 50. The blade open-close device 1 is mounted on the surface of the module board 2 on which the lens unit 3 is mounted.

As shown in FIGS. 2 and 3, the base 10 has a substantially rectangular accommodating space S accommodating the lens unit 3 mounted on the module board 2. The partition 30 has an opening 31. The cover plate 40 has an opening 41. The openings 31 and 41 are aligned with an optical axis P of the lens unit 3. In the present embodiment, the partition 32 is separate from the partition 30 having the opening 31. However, the partition 30 having the opening 31 and the partition 32 may be integral as a single partition. In another embodiment, the partition 30, the partition 32, or both may be eliminated. When the partition 30 is eliminated, an aperture (described later) is defined by the opening 41 in the cover plate 40.

The cover plate 40 is fastened to the base 10 with pins 42 and 43 together with, for example, the partitions 30 and 32. Rather than with pins, the cover plate 40 may be fastened to the base 10 with, for example, screws.

The actuator 20 includes a yoke 21 formed from a magnetic material, a coil base 22, a coil 23 wound around the yoke 21 and the coil base 22, a rotor magnet 24 rotatably attached to a shaft 11 extending in the positive Z-direction from the base 10, and a lever 25 connected to the rotor magnet. The yoke 21 in the present embodiment is thin and flat in Z-direction. The yoke 21 is U-shaped and includes two arms 21A and 21B. The coil 23 is wound around the arm 21A. The rotor magnet 24 is located between the arms 21A and 21B of the yoke 21. The rotor magnet 24 includes a magnet having different magnetic poles around the shaft 11. The lever 25 includes a cylindrical engagement part 26 (connecting part) extending in the positive Z-direction radially outside the rotor magnet 24.

The coil base 22 includes terminals 27 protruding in the negative Y-direction. The ends of the coil 23 are wound around the terminals 27. The ends of the coil 23 are fixed to the terminals 27 with, for example, solder joints 60 together with a metal terminal plate 28 as shown in FIG. 1. The terminal plate 28 extends parallel to an XZ plane and includes connectors 29 at its end adjacent to the module board 2 (in the negative Z-direction). The connectors 29 are electrically connected to contacts 2A on the module board 2 with, for example, solder joints 61 as shown in FIG. 1. In this manner, the coil 23 in the actuator 20 is electrically connected to wiring (not shown) in the module board 2 with the terminal plate 28.

The blade 50 includes a base plate 52 having a cam groove 51 and a blade plate 53 attached to the base plate 52. The cam groove 51 extends in the negative Y-direction, gradually redirecting in the positive X-direction. The cam groove 51 has a width in X-direction slightly larger than the outer diameter of the engagement part 26 of the lever 25 in the actuator 20. In the present embodiment, the base plate 52 and the blade plate 53 are separate, but may be integrated into the blade 50. In another embodiment, the blade 50 may be movable without the cam groove 51.

The blade 50 is located between guides 12 extending in the positive Z-direction from the edge of the base 10 in Y-direction (refer to FIG. 2). The blade 50 is thus movable in X-direction while being guided by the guides 12 of the base 10. More specifically, the blade 50 is movable in X-direction in a blade chamber defined between the cover plate 40 and the partitions 30 and 32.

The partition 30 has the opening 31 (aperture) that determines the amount of light entering the lens unit 3. Thus, the partition 30 may be referred to as an aperture blade. When the partition 30 is eliminated, the opening 41 in the cover plate 40 functions as the aperture.

The partition 32 has an arc-shaped groove 33 along an arc with the shaft 11 on the base 10 at the center. The arc-shaped groove 33 has a width in the radial direction slightly larger than the outer diameter of the engagement part 26 of the lever 25 in the actuator 20. The engagement part 26 of the lever 25 is placed in the cam groove 51 in the blade 50 through the arc-shaped groove 33 in the partition 32, and thus functions to connect to the blade 50. The engagement part 26 of the lever 25 can thus move in the arc-shaped groove 33 in the partition 32 along the arc with the shaft 11 on the base 10 at the center, and can also move in the cam groove 51 while engaging with the cam groove 51 in the blade 50. The engagement part 26 of the lever 25 in the actuator 20 engages with the cam groove 51 in the blade 50 to move the blade 50 in X-direction as the engagement part 26 of the lever 25 in the actuator 20 moves.

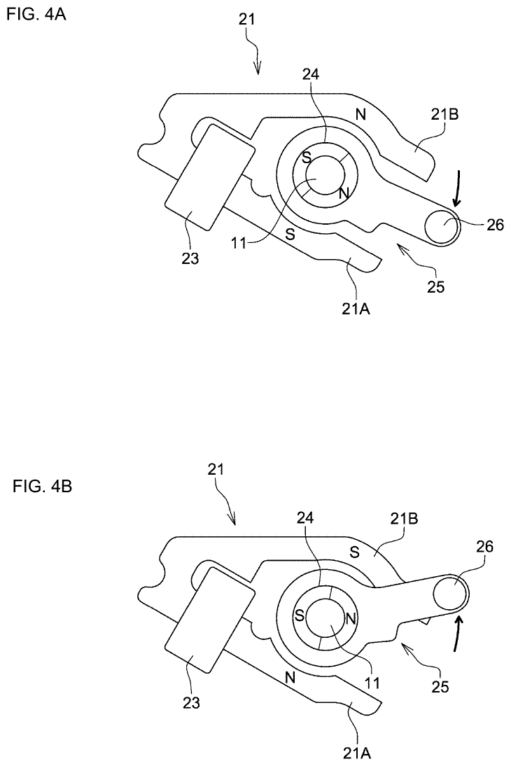

FIGS. 4A and 4B are schematic plan views of the actuator 20, each showing its example operation. In the actuator 20 in the present embodiment, a current flows through the coil 23 in the actuator 20 through the wiring of the module board 2, causing the arms 21A and 21B of the yoke 21 to be magnetically polarized (magnetized) oppositely to each other. The magnetic forces of the arms 21A and 21B then attract and rotate the rotor magnet 24.

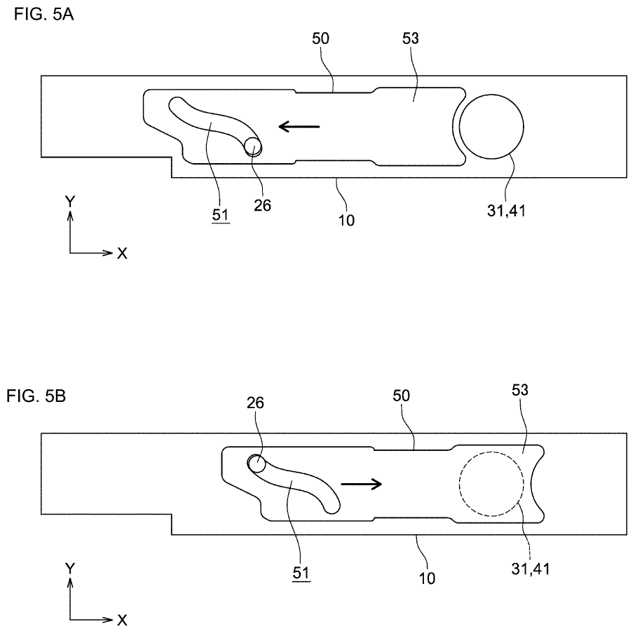

For example, when a current flows through the coil 23 in the actuator 20 in one direction to cause the arms 21A and 21B of the yoke 21 to be magnetically polarized or magnetized as shown in FIG. 4A, the magnetic poles of the arms 21A and 21B of the yoke 21 attract the respective opposite magnetic poles of the rotor magnet 24, thus rotating the rotor magnet 24 clockwise about the shaft 11. At this time, the engagement part 26 of the lever 25, engaged with the cam groove 51 in the blade 50, moves the blade 50 in the negative X-direction to the position shown in FIG. 5A. The blade 50 at this position does not cover the opening 31 in the partition 32 and the opening 41 in the cover plate 40, thus leaving the openings 31 and 41 uncovered. This allows external light to directly enter the lens in the lens unit 3 through the opening 31 in the partition 32 and the opening 41 in the cover plate 40, thus enabling image capturing with the lens unit 3. The position of the rotor magnet 24 shown in FIG. 4A and the position of the blade 50 shown in FIG. 5A are each hereafter referred to as an opening position.

When a current in a direction opposite to the direction of the current in FIG. 4A flows through the coil 23 in the actuator 20 to cause the arms 21A and 21B of the yoke 21 to be magnetically polarized as shown in FIG. 4B, the magnetic poles of the arms 21A and 21B of the yoke 21 attract the respective opposite magnetic poles of the rotor magnet 24, thus rotating the rotor magnet 24 counterclockwise about the shaft 11. At this time, the engagement part 26 of the lever 25, engaged with the cam groove 51 in the blade 50, moves the blade 50 in the positive X-direction to the position shown in FIG. 5B. The blade 50 (blade plate 53) at this position covers the opening 31 in the partition 32 and the opening 41 in the cover plate 40. More specifically, the blade 50 aligns with the optical axis P of the lens unit 3, blocking light passing through the opening 41 in the cover plate 40. The position of the rotor magnet 24 shown in FIG. 4B and the position of the blade 50 shown in FIG. 5B each are hereafter referred to as a closing position.

In this manner, the actuator 20 rotates the rotor magnet 24 between the closing position and the opening position with power from the module board 2, thus enabling the blade 50 to move between the closing position and the opening position with the engagement part 26 of the lever 25.

The blade plate 53 formed from, for example, a material opaque to light to be captured by the lens unit 3 (e.g., visible light and infrared light) blocks light passing through the opening 41 in the cover plate 40 when the blade 50 is at the closing position, preventing the light from reaching the lens unit 3. In this state, the lens unit 3 in operation is not allowed to capture images or videos. This prevents images or videos unintended by the user from being obtained.

The blade plate 53 of the blade 50 may not fully block light entering the lens unit 3 through the openings 41 and 31, and may partially block light entering the lens unit 3. To partially block light entering the lens unit 3, for example, the blade plate 53 may be formed from a material having a low transmittance to light to be captured by the lens unit 3 (e.g., visible light and infrared light), may be colored, or may be patterned with irregularities or holes (e.g., a reticulated or grid pattern and a concentric circle pattern). This causes images or videos captured by the lens unit 3 to be partly unclear or invisible, thus preventing images or videos unintended by the user from being obtained.

The blade plate 53 may have a predetermined optical effect (e.g., a mosaic filter, scattering, and diffuse reflection) to light entering the lens unit 3 through the openings 41 and 31. Such a blade plate 53 also causes images or videos captured by the lens unit 3 to be partly unclear or invisible, thus preventing images or videos unintended by the user from being obtained.

In the present embodiment, the yoke 21 is shaped to attract the rotor magnet 24 under the magnetic force from the rotor magnet 24 without any current flowing through the coil 23 in the actuator 20. More specifically, when a current flowing through the coil 23 in the actuator 20 is stopped in the state shown in FIG. 4A, the rotor magnet 24 can remain at the opening position with its magnetic force acting on the yoke 21. Similarly, when a current flowing through the coil 23 in the actuator 20 is stopped in the state shown in FIG. 4B, the rotor magnet 24 can remain at the closing position with its magnetic force acting on the yoke 21.

In this manner, the yoke 21 can be shaped to prevent the blade 50 from unintendedly moving from the opening position or the closing position or from stopping between the opening position and the closing position without any current flowing through the coil 23 in the actuator 20. The yoke 21 may be shaped to retain the rotor magnet 24 at either the opening position or the closing position. In particular, retaining the rotor magnet 24 at the closing position causes the blade plate 53 of the blade 50 to cover the openings 41 and 31 without any current flowing through the coil 23 in the actuator 20. This can prevent images or videos unintended by the user from being obtained.

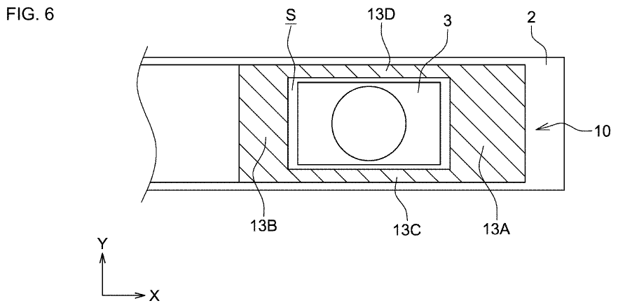

FIG. 6 is a partial cross-sectional view of the blade open-close device 1. As shown in FIG. 6, the base 10 includes peripheral walls 13A, 13B, 13C, and 13D that are adjacent to and surround the lens unit 3. The peripheral walls 13A, 13B, 13C, and 13D, the partition 30, and the module board 2 thus define the accommodating space S accommodating the lens unit 3.

In FIG. 3, T≤(H₁+H₂)/5 (1)

where T is the distance from an upper surface 13E of the peripheral walls 13A, 13B, 13C, and 13D of the base 10 (in other words, an inner surface 30A of the partition 30 adjacent to the base 10) to a surface 40A of the cover plate 40 opposite to the base 10 along the optical axis P (outer surface 40A of the cover plate 40), H₁ is the height of the lens unit 3 along the optical axis P, and H₂ is the thickness of the module board 2 along the optical axis P.

In one example, when the height H₁ of the lens unit 3 is 1.0 mm and the thickness H₂ of the module board 2 is 0 5 mm, the distance T from the inner surface 30A of the partition 30 to the outer surface 40A of the cover plate 40 is 0.3 mm or less. In another example, when the height H₁ of the lens unit 3 is 1.2 mm and the thickness H₂ of the module board 2 is 0.3 mm, the distance T from the inner surface 30A of the partition 30 to the outer surface 40A of the cover plate 40 is 0.3 mm or less. The thickness H₂ of the module board 2 changes in accordance with the number of wiring layers included in the board. The module board 2 can include, for example, four wiring layers or six wiring layers. A total thickness Hs of the module board 2 and the blade open-close device 1 is, for example, 2.5 mm When the partitions 30 and 32 are eliminated, the distance T may be a distance from the upper surface 13E of the peripheral walls 13A, 13B, 13C, and 13D of the base 10 to the outer surface 40A of the cover plate 40.

The blade open-close device 1 satisfying formula (1) has a space for accommodating the blade 50 with a thickness that is effectively reduced with respect to the height of a camera module including the module board 2 and the lens unit 3. This reduces the likelihood that the camera module cannot be incorporated in a limited space such as in an electronic device due to the height of the blade open-close device 1 in the optical axis direction.

When the blade 50 is at the closing position, the outer surface of the blade plate 53 of the blade 50 is exposed outside through the opening 41 in the cover plate 40. The outer surface of the blade plate 53 may by colored with a highly visible color (e.g., red) or may be designed with, for example, a highly visible geometrical pattern (e.g., a star, a square, or a polygon), a logo, or an illustration. The blade plate 53 having such an outer surface with a highly visible color or design allows the user to easily view the blade plate 53 being at the closing position and to easily learn that the user is protected from unintended image or video capturing.

Although the opening 41 in the cover plate 40 and the opening 31 in the partition 30 are circular in the illustrated embodiment, the openings 41 and 31 may not be circular, and may be of any shape such as rectangular and elliptical.

Although the actuator 20 includes the flat U-shaped yoke 21 and the rotor magnet 24 in combination in the above embodiment, the actuator 20 to be used is not limited to this structure, and may have any structure that can move the blade 50 between the closing position and the opening position.

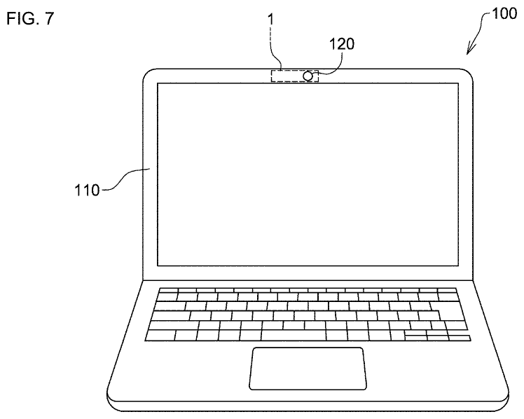

FIG. 7 is a schematic diagram of a laptop personal computer 100 as an example electronic device incorporating the above blade open-close device 1. A lid 110 of the laptop personal computer 100 has a window 120 for a camera. The blade open-close device 1 is incorporated in the laptop personal computer 100 with the lens unit 3 at a position corresponding to the window 120. This implements the laptop personal computer 100 having the camera function.

Although the electronic device incorporating the blade open-close device 1 is the laptop personal computer 100 in the above example, the blade open-close device according to one or more embodiments of the present invention may be used in many electronic devices having the camera function, in addition to laptop personal computers, such as smart speakers and home security cameras.

Although the embodiments of the present invention have been described above, the present invention is not limited to the above embodiments and may be modified variously within the scope of its technical idea.

As described above, a thin blade open-close device according to a first aspect of the present invention can be incorporated in a limited space. The blade open-close device is mountable on a module board including a lens unit. The blade open-close device includes a base located on the module board and including walls adjacent to the lens unit and a cover plate covering at least part of the base. The cover plate has an opening aligned with an optical axis of the lens unit. The blade open-close device includes a blade movable in a direction perpendicular to the optical axis in a blade chamber defined between the cover plate and an upper surface of the walls of the base and an actuator that moves the blade between a closing position to cover the opening and an opening position to uncover the opening. A distance from the upper surface of the walls of the base to a surface of the cover plate opposite to the base along the optical axis is one fifth or less of the total of the thickness of the module board and the height of the lens unit measured along the optical axis.

The blade open-close device with the structure can thus have a space for accommodating the blade with a thickness effectively reduced with respect to the height of the camera module including the module board and the lens unit. This reduces the likelihood that the camera module cannot be incorporated in a limited space such as in an electronic device due to the height of the blade open-close device.

The actuator may include a flat U-shaped yoke including two arms, a coil wound around one of the two arms of the yoke, a rotor magnet rotatably located between the two arms of the yoke, and a lever connected to the rotor magnet. The lever includes a connecting part connected to the blade.

The blade open-close device may be mounted on a surface of the module board on which the lens unit is mounted. The walls of the base may surround the lens unit.

The actuator may retain the blade at least at one of the opening position or the closing position without any current flowing through the actuator.

The blade may at least partially block light entering the lens unit through the opening to obstruct image capturing performed by the lens unit. The blade may also have a predetermined optical effect to light entering the lens unit through the opening to obstruct image capturing with the lens unit. The blade may have an outer surface having a visible color or design.

An electronic device according to a second aspect of the present invention includes a module board, a lens unit mounted on the module board, and the blade open-close device described above.

What is claimed is:

1. A blade open-close device mountable on a module board including a lens unit, the device comprising:
a base located on the module board and including walls adjacent to the lens unit;
a cover plate covering at least part of the base and having an opening aligned with an optical axis of the lens unit;
a blade movable in a direction perpendicular to the optical axis in a blade chamber defined between the cover plate and an upper surface of the walls of the base; and
an actuator configured to move the blade between a closing position to cover the opening and an opening position to uncover the opening,
wherein a distance from the upper surface of the walls of the base to a surface of the cover plate opposite to the base along the optical axis is one fifth or less of a total of a thickness of the module board and a height of the lens unit measured along the optical axis.

2. The blade open-close device according to claim 1, wherein
the actuator includes
a flat U-shaped yoke including two arms,
a coil wound around one of the two arms of the yoke,
a rotor magnet rotatably located between the two arms of the yoke, and
a lever connected to the rotor magnet and including a connecting part connected to the blade.

3. The blade open-close device according to claim 1, wherein
the blade open-close device is mounted on a surface of the module board on which the lens unit is mounted.

4. The blade open-close device according to claim 3, wherein
the walls of the base surround the lens unit.

5. An electronic device, comprising:
a module board;
a lens unit mounted on the module board; and
the blade open-close device according to claim 1.
